(19) United States
(12) Patent Application Publication
(10) Pub. No.: US 2026/0328241 A1
(43) Pub. Date: Oct. 22, 2026

(54) CONNECTOR, BATTERY ARRANGEMENT, FUEL CELL AND METHOD FOR MANUFACTURING A CONNECTOR

(71) Applicant: KAMAX Holding GmbH & Co. KG, Homberg (Ohm) (DE)

(72) Inventors: Dennis Dutenhöfner, Homberg (Ohm) (DE); Johannes Schwalm, Bingen (DE); Claudia Pöggeler Ribas, Marburg (DE)

(73) Assignee: KAMAX Holding GmbH & Co. KG, Homberg (Ohm) (DE)

(21) Appl. No.: 19/099,393

(22) PCT Filed: Jul. 11, 2023
(86) PCT No.: PCT/EP2023/069178

§ 371 Date: Jan. 28, 2025

(30) Foreign Application Priority Data
Jul. 29, 2022 (DE) 102022119087.0
Nov. 29, 2022 (DE) 102022131561.4
Nov. 29, 2022 (DE) 102022131562.2

(51) Int. Cl. F16B 33/00; H01M 8/02; H01M 10/02

(52) U.S. Cl. CPC F16B 33/00; H01M 8/02; H01M 10/02

(57) ABSTRACT

Connector (1), in particular a screw or bolt, comprising an actuation area (10), in particular a head, an elasticity area (30) and a mounting area (50), wherein the connector (1) extends in a longitudinal direction (L), wherein a radial direction (R) is in particular perpendicular to the longitudinal direction (L), wherein the elasticity area (30) lies in the longitudinal direction (L) between the actuation area (10) and the mounting area (50), wherein the mounting area (50) has a thread, in particular an internal thread, wherein the elasticity area (30) has stiffness reduction structures (34), in particular in the form of recesses and/or openings, and/or wherein the elasticity area (30) has a lower elasticity than the mounting area (50) and/or than the actuation area (10) due to its geometry, and/or wherein the elasticity area has a degressive spring characteristic.

### CROSS-REFERENCE TO RELATED APPLICATIONS

This application is a U.S. National Stage Application under 35 U.S.C. § 371 of International Application No. PCT/EP2023/069178, filed Jul. 11, 2023, which claims the benefit of and priority to German Patent Application Nos. DE 10 2022 119 087.0, filed Jul. 29, 2022, DE 2022 131 561.4, filed Nov. 29, 2022, and DE 10 2022 131 562.2, filed Nov. 29, 2022, the contents of which are hereby incorporated herein by reference in their entireties.

### TECHNICAL FIELD

The invention relates to a connector, a battery arrangement, a fuel cell and a method for manufacturing a connector.

### BACKGROUND

Connectors are already known in the state of the art. They are used to connect different components together, particularly reversibly. However, the problem is that if the components to be connected expand during operation, as can be the case with fuel cells or battery arrangements, for example, an enormous load is exerted on the connector or on the components that are connected, or the connector may come loose.

### SUMMARY

The aim of the invention is therefore to provide a connector which allows even high dynamic or static expansions to be safely absorbed and/or the resulting load on the connector or the connected components to be reduced.

This problem is solved with a connector according to claim 1, with a battery arrangement and/or a fuel cell according to claim 14 and with a method for manufacturing a connector according to claim 15. Further advantages, features and embodiments are shown in the sub-claims, the description and the drawings.

According to the invention is a connector, in particular a screw or a bolt. Advantageously, the connector comprises an actuation area, in particular a head, an elasticity area and preferably a mounting area, wherein the connector extends in a longitudinal direction, wherein a radial direction is in particular perpendicular to the longitudinal direction, wherein the elasticity area can lie in the longitudinal direction between the actuation area and the mounting area, wherein the mounting area has a thread, in particular an internal thread, wherein advantageously or optionally the elasticity area and/or the mounting area are or may be hollow on the inside, and/or wherein the elasticity area has a lower elasticity than the mounting area and/or than the actuation area due to its geometry. The connector is used in particular to connect different components to each other, especially by friction locking This friction locking connection relates in particular to transverse forces, advantageously in the radial direction or parallel to this direction. In order to be able to establish or transmit a transverse force, in particular perpendicular to the longitudinal direction, between the connected components, the connector is therefore advantageously designed as a friction-locking connector. In particular the connector has an actuation area. The actuation area is advantageously used to apply a mounting torque to the connector, particularly by friction locking. For this purpose, the actuation area can have actuation surfaces, in particular in the form of an external hexagon, internal hexagon, external or internal hexalobular, a multi-tooth and/or a multi-round, in each case advantageously as an internal and/or external actuation. It is expedient for the normal lines of the actuation surfaces to face in the radial direction. These actuation surfaces can be part of a head, which in turn can form the actuation area. In other words, the actuation area can therefore be formed by or comprise a head. It is expedient for the actuation area to be designed in such a way that it forms a distal end of the connector in the longitudinal direction. The longitudinal direction, in turn, is in particular the direction in which the connector has its largest main dimension. For example, the longitudinal direction may therefore or alternatively preferably be the direction in which the length of the connector is measured. The center of gravity of the connector, the elasticity area and/or the assembly area may be in the longitudinal direction. In particular, one of the radial directions or the radial direction extends perpendicular to the longitudinal direction. Advantageously, the longitudinal direction, the radial direction and a circumferential direction form a cylindrical coordinate system. In addition to the actuation area, the connector also has an elasticity area and/or an assembly area. The mounting area of the connector has a thread to form a connection with another thread, in particular a nut thread. This thread can advantageously be designed as an internal thread in order to achieve an extremely space-saving configuration. Alternatively or additionally preferably, the thread of the mounting area can also be an external thread. This makes it particularly easy to manufacture. The thread itself can be a metric or imperial thread. Preferably, the mounting area is limited in the longitudinal direction by the distal ends of the thread. Advantageously, the assembly area forms a distal end of the connector in the longitudinal direction. The mounting area, which has the thread and/or which is formed by the thread, can limit the connector in the longitudinal direction. To reduce the risk of injury during assembly, the assembly area can be limited by and/or have a cylindrical surface facing outwards in the radial direction. The elasticity area is located between the actuation area and the mounting area when viewed in the longitudinal direction. Advantageously, the length of the elasticity area in the longitudinal direction is greater than the length of the actuation area and/or the mounting area in the longitudinal direction. The lengths of all areas are measured in the longitudinal direction. Expediently, the length of the elasticity area in the longitudinal direction is greater than the sum of the lengths of the actuation area and the mounting area. Advantageously, at least 30%, preferably at least 60% and particularly preferably at least 70% of the length of the connector in the longitudinal direction is formed by the elasticity area. The elasticity area and/or the mounting area are hollow on the inside, in order to create or provide easy mounting and/or a gas channel and/or a reduction in elasticity. Due to its geometry, the elasticity area is designed in such a way that it has a lower elasticity than the assembly area, whereby the elasticity area has deformation structures and/or stiffness reduction structures, in particular in the form of deformation structures. In other words, the geometry of the elasticity area in particular is such that this results in a lower elasticity in the mounting area than the elasticity in the mounting area and/or in the actuation area. The elasticity itself is in particular equivalent to the spring stiffness or the gradient of the force-path diagram. The measure of elasticity is the elasticity in the longitudinal direction. In particular, this force-path diagram or the spring stiffness is not nondimensionalised by a geometric parameter. In other words, the elasticity or spring stiffness is not therefore determined by the gradient of the stress-strain diagram but by the force actually applied to the elasticity area in comparison to the resulting displacement or deformation. The force-path diagram therefore shows the force that must be applied to separate the mounting area from the actuation area in the longitudinal direction, while at the same time absorbing the resulting displacement of the actuation area in the longitudinal direction to the mounting area. Advantageously, the elasticity area and the assembly area and/or the elasticity area and the actuation area are made of the same material and/or in one piece. This allows particularly good mechanical durability to be achieved. Due to the lower elasticity of the elasticity area—because of the geometry of the elasticity area and/or the stiffness reduction structures—a load—caused by a swelling and/or static expansion of the connected components—can be reduced. In particular, this can reduce the load on the connector and/or the components to be braced or already braced, so that the operational safety and durability of the connector can be increased. A further advantage of such a design is that the dynamic loads on the connector are also reduced. The connector according to the invention can in particular also be a fastener and/or vice versa.

Advantageously, the elasticity area has one or a plurality of deformation structures which are or will be subjected to bending and/or torsion when the actuation area is displaced in the longitudinal direction in relation to the mounting area. Deformation structures are in particular spirals or beam segments, which can be achieved, for example, by introducing indentations and/or openings or other stiffness reduction structures into the elasticity area, in particular in the radial direction. These deformation structures are therefore in particular not recesses but material areas which are mechanically stressed due to the change in length in the longitudinal direction of the elasticity area, in particular due to a displacement of the mounting area in the longitudinal direction in relation to the actuation area. This mechanical stress on the deformation structures is in particular or comprises in particular a bending load and/or a torsional load. This type of stress is in particular the predominant type of stress, therefore in particular the type of stress that causes at least 30%, preferably at least 50% and particularly preferably at least 70% of the equivalent stress, in particular when applying the shape change hypothesis (von Mises) and/or the principal normal stress hypothesis (Rankine). In particular, this can increase the achievable reversible degrees of deformation of the deformation structures, so that ultimately the elasticity of the elasticity area can be reduced. In other words, the spring stiffness of the elasticity area, which may be a synonym for its elasticity, can therefore be reduced by using deformation structures which are subjected to bending and/or torsion when the actuation area is displaced in the longitudinal direction in relation to the mounting area. This allows a particularly advantageous design of the elasticity area to be achieved.

Advantageously, the elasticity area is designed in such a way that it has a degressive spring characteristic. In other words, the elasticity or the spring stiffness of the elasticity area—with regard to a displacement of the actuation area in the longitudinal direction in relation to the mounting area—can therefore be such that the elasticity is reduced or decreases with increasing spacing of the actuation area in the longitudinal direction in relation to the mounting area. In particular, this allows the dynamic loads to be further reduced as the connected components expand or the resulting (static) load to increase less. Advantageously, the spring characteristic is degressive in the elastic area. In other words, a degressive spring characteristic is therefore already achieved “before” irreversible deformation occurs. In particular, this can minimise and/or reduce permanent stress relief and/or mechanical overstressing of the connected components and/or the connector.

Advantageously, the elasticity area has one or a plurality of stiffness reduction structures, in particular indentations and/or openings, whereby the stiffness reduction structures form or limit the deformation structures. In other words, indentations and/or other stiffness reduction structures which border the deformation structures can be formed in the elasticity area, in particular in the radial direction. In particular, these indentations can be designed in such a way that they allow fluid to pass through from the surrounding area via the recess or depression or opening into the internal hollow area or the overall hollow internal elasticity area. In other words, the opening or openings can be designed in such a way that they extend from the outside into the hollow interior of the elasticity area.

The internal hollow area of the connector can be formed in particular by a central recess which extends from the assembly area into the elasticity area or even into the actuation area in the longitudinal direction. By providing such a central recess, a fluid flow can therefore also occur between the individual areas of the connector in the longitudinal direction.

Advantageously, the stiffness reduction structures, in particular in the form of an indentation or indentations, connect an outer wall of the elasticity area with an inner wall of the elasticity area. The outer wall of the elasticity area borders this on the outside, in particular in the positive radial direction, and the inner wall borders the elasticity area, particularly on the inside in the longitudinal direction. In particular, this inner wall can border and/or partially form the central recess. This enables a particularly effective and direct flow of fluid from the surroundings into the hollow interior of the elasticity area, as already explained.

Advantageously at least one stiffness reduction structure, in particular in the form of an indentation, is expediently designed in such a way that its projection in the longitudinal direction covers itself. In other words, at least one indentation can be formed in such a way that when this indentation is projected onto a plane perpendicular to the longitudinal direction, the projection is closed in on itself and can therefore forms a ring around the longitudinal direction in particular. This allows a particularly high degree of elasticity reduction to be achieved, resulting in a particularly advantageous elasticity area Advantageously, however, the ends of the indentation forming the projection which overlaps on itself or is closed in on itself are located at different height positions in the longitudinal direction. In other words, the indentation, which may in particular be an opening, is only closed in on itself in the projection and not when the indentation is viewed taking into account the extension in the longitudinal direction. In particular, this can prevent drastic weakening of the connector.

Advantageously, the elasticity area has one or more helical indentations and/or stiffness reduction structures, in particular openings, so that the elasticity area has one or more and/or a plurality of deformation structures, which is and/or are a spiral. By providing spiral-shaped indentations and/or stiffness reduction structures, which can be openings in particular, it is possible to achieve a particularly effective way of loading the deformation structures for torsion. By providing deformation structures that are subjected to torsion, a particularly high degree of reversible deformation capacity can be provided. By providing helical deformation structures, a particularly good torsional load can be achieved. As already mentioned, several spirals can also be provided, so that multi-start deformation structures can be present in a helical form. In other words, the multi-start helical deformation structures can be designed in a similar way to a multi-start thread.

Advantageously, a deformation structure, in particular a spiral, has a material thickness in the longitudinal direction and a material thickness in the radial direction, which can also be referred to as radial thickness, whereby the ratio of the material thickness to the radial thickness is in the range of 0.8 to 1.2, preferably in the range of 0.9 to 1.1, and particularly preferably in the range of 0.97 to 1.03. The material thickness is therefore the average and/or the maximum or minimum material thickness of the deformation structure measured in the longitudinal direction. The radial thickness of the deformation structure is in particular the material thickness or the material thickness in the radial direction. Advantageously, the ratio of the material thickness to the radial thickness is in the range of 0.8 to 1.2. This makes it particularly easy to manufacture. However, if the material thickness is in the range of 0.9 to 1.1, a particularly advantageous stress distribution can be achieved. If, on the other hand, the ratio is in the range of 0.97 to 1.03, an almost homogeneous stress distribution can be achieved on all the edges.

Advantageously, at least one indentation and/or stiffness reduction structure, preferably a plurality of indentations and/or stiffness reduction structures, should have a slotted hole shape. Preferably, the or at least one, preferably at least a predominant number, and particularly preferably all indentations or stiffness reduction structures which have a slotted hole shape are formed as openings. An indentation/stiffness reduction structure is to be regarded as having a slotted hole shape in particular if it has a larger dimension in its main direction of extension than perpendicular to it. In other words, a slotted hole indentation or slotted opening can therefore be present if the length in the circumferential direction of the opening is greater than the length of the opening in the longitudinal direction. In particular, the length of the opening and/or the indentation in the radial direction is irrelevant. In other words, only the contour that the indentation and/or the opening leaves on an outer wall of the elasticity area therefore determines if it has a slotted hole shape in particular. It is expedient for the slotted opening or slotted indentation to be larger in particular in the circumferential direction than in the longitudinal direction. Advantageously, the extension in the circumferential direction is at least 10%, preferably at least 20% and particularly preferably at least 30% greater in the longitudinal direction in order to be defined as a slotted shape. Advantageously, the distal end areas of the slotted opening or the slotted indentation are formed by a rounding. This can reduce the material stress increase or the stress increase factor.

Preferably, the projections of the slotted hole indentation or stiffness reduction structures form a closed circle in the direction of the longitudinal direction, in particular in the longitudinal direction. In other words, the projections of the elongated slotted indentation, which could in particular be openings, can therefore be formed in such a way that, when viewed in the longitudinal direction, they overlap in such a way that a complete circle or a self-contained ring is formed, whereby in particular the center of gravity of this ring lies in the longitudinal direction and/or the ring surrounds the longitudinal direction. This allows a particularly advantageous reduction in the elasticity of the elasticity area to be achieved.

Preferably, at least one slotted hole indentation and/or stiffness reduction structure has a variable width in the longitudinal direction. The width is in particular the spacing of the opposite walls in the longitudinal direction. In particular, the slotted opening or slotted indentation is orientated so that it extends perpendicular to the longitudinal direction. In other words, the main direction of extension is therefore orientated perpendicular to the longitudinal direction with a projection in the radial direction. The variable width in the longitudinal direction means that a defined stress distribution can be achieved. Advantageously, the width of the slotted opening or indentation decreases towards the center of the opening or indentation. In other words, the width of the indentation can initially decrease from one distal end of the opening or indentation towards the other distal end of the indentation and then increase again once the center between the distal ends of the indentation has been crossed. This can pre-empt the mechanical stress that occurs in a particularly advantageous way. In other words, it can be used to achieve a design that is particularly well adapted to the stress.

Advantageously, a deformation structure, in particular a deformation structure arranged between two slotted openings, has a material thickness, in particular a maximum material thickness, in the direction of the longitudinal direction and a material thickness, in particular a maximum material thickness, in the direction of the radial direction, which—as previously explained—can be described as the radial thickness, whereby the ratio of the material thickness to the radial thickness is in the range of 0.7 to 1.3, preferably in the range of 0.85 to 1.15, and particularly preferably in the range of 0.9 to 1.1. As previously explained, the material thickness is in particular the average and/or the maximum or minimum material thickness of the deformation structure measured in the longitudinal direction. The radial thickness of the deformation structure is-as previously explained-in particular the material thickness or the material thickness in the radial direction. Advantageously, the ratio of the material thickness to the radial thickness is in the range of 0.7 to 1.3. This enables particularly cost-effective production, especially if the deformation structure is at least partially limited in the longitudinal direction by slotted openings. If, on the other hand, the material thickness is in the range of 0.85 to 1.15, a particularly low local stress concentration can be achieved, especially if the deformation structure is at least partially limited in the longitudinal direction by slotted openings. If, on the other hand, the ratio is in the range of 0.9 to 1.1, a particularly good increase in elasticity can be achieved.

Advantageously, the ratio of the average height or the maximum height of the openings, in particular the openings which are slotted, in the longitudinal direction to the diameter of the elasticity area is in a ratio of 0.045 to 0.125, preferably in a range of 0.055 to 0.0834, particularly preferably in a range of 0.06 to 0.75. The average height or the maximum height of the openings in the longitudinal direction is the width of the opening in the longitudinal direction, in particular between two opposite walls in the longitudinal direction. The average height, on the other hand, is the average height of the opening in the longitudinal direction between one distal end and the other distal end in the direction of the opening. The diameter of the elasticity range, on the other hand, is the diameter of the smallest possible circle lying in a plane perpendicular to the longitudinal direction that just surrounds the elasticity area. If the ratio is in the range of 0.045 to 0.125, a particularly effective reduction in elasticity can be achieved. If, on the other hand, the ratio is in the range of 0.055 to 0.0834, this makes it particularly easy to manufacture.

Advantageously, the connector is designed as a single piece. A one-piece design means in particular that the material of the connector has been joined together in a single original moulding process. In other words, the connector may have been further processed after this primary moulding process, in particular by separating or splitting processes, such as laser cutting and/or thread cutting and/or milling or turning, but no further elements have been added to the connector, e.g. by welding. Advantageously, however, only the actuation area, the elasticity area and the assembly area are formed in one piece. Alternatively or additionally preferably, the connector can also result from joining further components to each other by material bonding, in particular by material bonding of the actuation area to the elasticity area and the assembly area. In addition, further elements can also be mounted on the connector in this bonded connection, so that ultimately the result is a connector with an actuation area, elasticity area and mounting area that have been joined together by material bonding, although further elements can be attached to the connector by friction locking and/or form locking and/or material bonding. Material bonding is particularly advantageous in terms of production costs. A one-piece design of the connector and/or the actuation area with the elasticity area and the assembly area, on the other hand, results in a particularly mechanically advantageous design.

Advantageously, the actuation area is hollow, in particular hollow inside. In particular, this allows a fluid flow in the hollow area of the actuation area through the elasticity area and/or through the mounting area. This means that the connector described here can be used particularly advantageously in a fuel cell. In particular, hollow means that the entire actuation area can be hollow in the longitudinal direction.

Advantageously, the actuation area has a gas connection. This makes it particularly easy to achieve gas flow from and/or into the actuation area. In particular, the gas connection can have or take the form of a gas-tight thread and/or a hose connection.

Advantageously, there is a central recess which extends longitudinally from the actuation area over the elasticity area and can reach as far as the mounting area. Advantageously, this central recess extends from the distal end of the mounting area to one distal end of the actuation area. In other words, a central recess can extend through the connector in the longitudinal direction in order to be able to provide fluid flow through the connector in particular. Advantageously, this central recess has a constant diameter in the actuation area, in the elasticity area and/or in the mounting area. This enables particularly simple and cost-effective production, which also has mechanically advantageous properties.

Expediently, the actuation area has actuation surfaces, with the actuation surfaces in particular having a normal in the radial direction. This allows a torque, in particular a form-fitting torque, in particular around the longitudinal direction, to be applied easily to the connector to mount the connector. By providing for the normal of the actuation surfaces to face in the radial direction, particularly cost-effective production can be achieved and actuation is easy.

Advantageously, one or a plurality of indentations and/or openings, in particular indentations and/or openings which form spirals and/or have a slotted hole shape, are laser-cut. This results in particularly cost-effective and precise production, so that localised (un-wanted) stress concentrations can be avoided and/or reduced.

A further aspect of the invention may relate to a battery arrangement and/or a fuel cell, whereby the battery arrangement or the fuel cell comprises a connector as described above and/or below.

A further aspect of the invention may relate to the use of a connector as described above and/or below in a battery arrangement or fuel cell and/or for a battery arrangement or fuel cell.

A further aspect of the invention may relate to a method of manufacturing a connector, in particular as described above and below. In particular, the method comprises the following steps:
Advantageous provision of a blank;
Moulding of an actuation area, in particular a head, advantageously by forming;
Moulding of an assembly area, in particular a hollow area, in particular by forming;
Moulding of an elasticity area, in particular by introducing stiffness reduction structures, advantageously in the form of indentations and/or openings, in the longitudinal direction between the actuation area and the mounting area.

The stiffness reduction structures can be created in particular by means of a laser, for example by laser cutting. The connector provided by the method of manufacture may in particular have the features, embodiments, design and advantages set out above and below. In particular, the moulding of the actuation area and/or the moulding of the elasticity area and/or the moulding of the assembly area is carried out by a forming process in order to achieve a particularly mechanically resilient and yet cost-effective design for a connector. In particular, the connector can be a screw and/or a bolt.

### BRIEF DESCRIPTION OF THE DRAWINGS

Further advantages and features of the present invention are shown in the following description with reference to the figures. Individual features of the embodiments shown can also be used in other embodiments, unless this has been expressly excluded. The figures include:

FIG. 1 a side view of a connector with stiffness reduction structures in slotted form;

FIG. 2 also a connector with stiffness reduction structures in the form of a recess, wherein the width of the stiffness reduction structures decreases towards the center;

FIG. 3 a partial view of a connector in a fuel cell;

FIG. 4 a plurality of connectors in a fuel cell;

FIG. 5 a side and sectional view of a connector; and

FIG. 6 a connector with a deformation structure that is a spiral.

### DETAILED DESCRIPTION

FIG. 1 shows a connector 1 that has an actuation area 10 in the form of a head. The actuation area 10 has a connection thread for a gas connection piece. In addition, the connector 1 also has a mounting area 50, whereby the attachment area 10 and the mounting area 50 form distally opposite end areas of the connector 1 in the longitudinal direction L. The elasticity area 30 is located between the attachment area 10 and the mounting area 50. Due to its geometry, the elasticity area 30 has a lower elasticity than the mounting area 50 and than the actuation area 10, and the elasticity area 30 has a degressive spring characteristic. These stiffness characteristics of the elasticity area 30 are achieved by the slotted stiffness reduction structures, which are designed as openings.

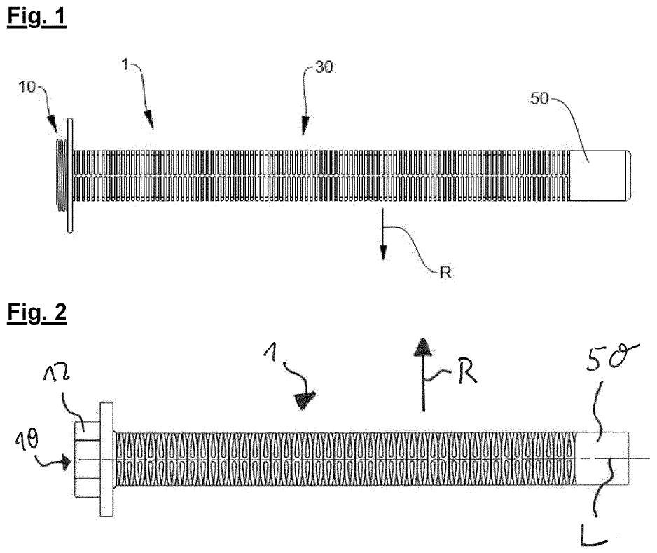

FIG. 2 shows a similar connector 1 to FIG. 1. However, the actuation area 10 has an external hexagon with actuation surfaces 12. In the mounting area 50, which is hollow on the inside, there is an internal thread for mounting. The radial direction R points radially from the longitudinal direction L. The deformation structures 32 present in the elasticity area 30 are such that they have a variable width in the longitudinal direction L, with the width decreasing towards the center of the recess.

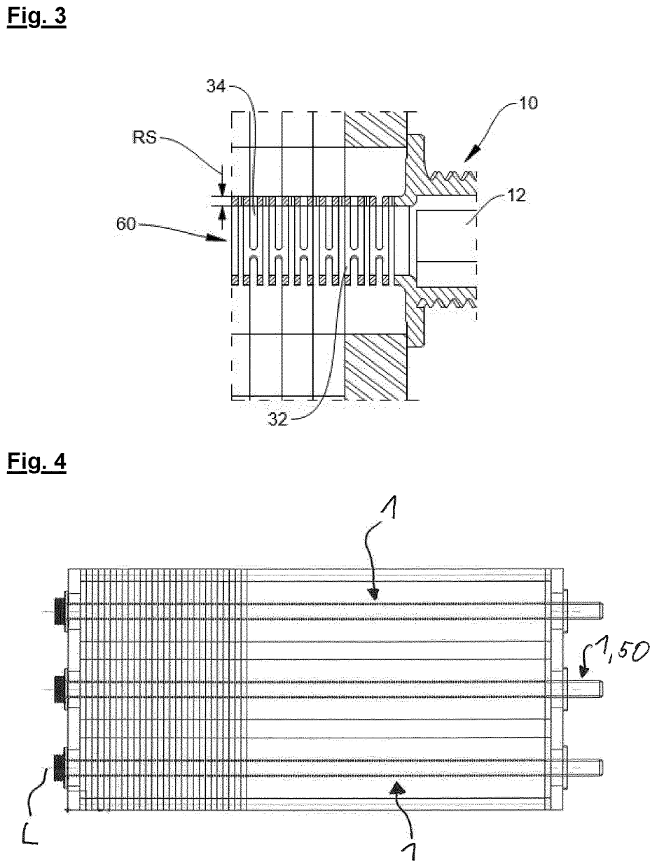

FIG. 3 shows a detailed view of a connector 1 mounted in a fuel cell. Both the actuation area 10, which has actuation surfaces 12 in its interior, and the elasticity area 30 are provided with a central recess 60, resulting in an internally hollow area both in the elasticity area 30 and in the actuation area 10. The stiffness reduction structures are designed in the form of slotted holes. The stiffness reduction structures 34 form the deformation structures 32, whereby the deformation structures 32 have a radial thickness RS in the radial direction R.

FIG. 4 shows a fuel cell which has a multitude of connectors 1. The connectors 1 run completely through the fuel cell in the longitudinal direction L.

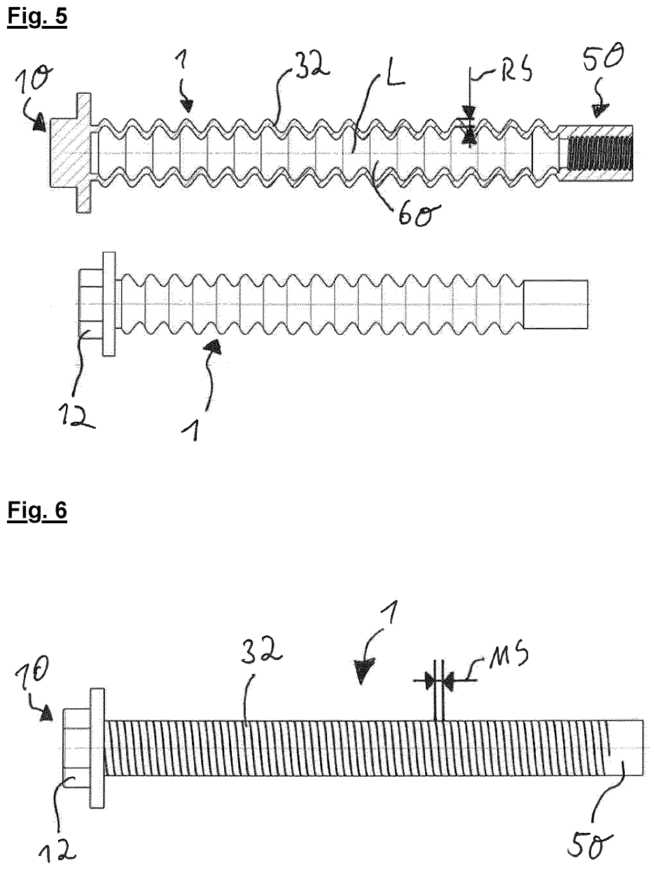

FIG. 5 shows a side view of the lower section and a sectional view through the upper section of a connector 1. The connector 1 extends in the longitudinal direction L. In the elasticity area 32, disc spring-like deformation structures 32 are arranged in series. This geometric design gives the elasticity area 30 a degressive spring characteristic. The radial thickness RS in the elasticity area can be seen. Both the mounting area 50 and the elasticity area 30 are hollow on the inside and therefore each have a section of the central recess 60. The mounting area 50 has an internal thread for mounting the connector 1.

FIG. 6 shows a connector 1. The connector 1 has a deformation structure 32, which is a spiral. In other words, the elasticity area 30 has a helical indentation which creates the deformation structure 32. The deformation structure 32 has a material thickness MS in the longitudinal direction L. Alternatively, instead of a helical indentation, a plurality of helical indentations can also be provided, resulting in a multi-start deformation structure or deformation structures in the form of a spiral. The mounting area 50 also has a metric internal thread.

### LIST OF REFERENCE NUMBERS

1—Connector
10—Actuation area, in particular the head
12—Actuation surface
30—Elasticity area
32—Deformation structures
34—Stiffness reduction structures, indentations, in particular openings
50—Mounting area
60—Central recess
L—Longitudinal direction
MS—Material thickness
R—Radial direction
RS—Radial thickness
U—Circumferential direction

1. A connector comprising:
an actuation area in the form of a head;
an elasticity area; and
a mounting area,
wherein the connector extends in a longitudinal direction,
wherein a radial direction is perpendicular to the longitudinal direction,
wherein the elasticity area lies in the longitudinal direction between the actuation area and the mounting area,
wherein the mounting area has an internal thread,
wherein the elasticity area and/or the mounting area are hollow, on the inside, and
wherein the elasticity area has (i) stiffness reduction structures in the form of recesses and/or openings, and/or
(ii) a lower elasticity than the mounting area and/or than the actuation area due to its geometry.

2. The connector according to claim 1, wherein the elasticity area has a plurality of deformation structures which are subjected to bending and/or torsion when the actuation area is displaced in the longitudinal direction in relation to the mounting area.

3. The connector according to claim 1, wherein the elasticity area has a degressive spring characteristic.

4. The connector according to claim 1, wherein the elasticity area has a plurality of stiffness reduction structures in the form of indentations and/or openings, and
wherein the stiffness reduction structures form or limit the deformation structures.

5. The connector according to claim 4, wherein at least one indentation of the stiffness reduction structures is formed in such a way that its projection in the longitudinal direction covers itself.

6. The connector according to claim 1, wherein the elasticity area comprises one or more helical indentations and/or stiffness reduction structures so that the elasticity area comprises one or more deformation structures in the form of a spiral.

7. The connector according to claim 6, wherein the one or more deformation structures has a material thickness in the direction of the longitudinal direction and a radial thickness in the radial direction,
wherein the ratio of the material thickness to the radial thickness is in the range of 0.8 to 1.2.

8. The connector according to claim 1, wherein the elasticity area has stiffness reduction structures that comprise a plurality of indentations that are slotted.

9. The connector according to claim 8, wherein the projections of the slotted indentations in the direction of the longitudinal direction form a closed circle around the longitudinal direction.

10. The connector according to claim 8, wherein at least one of the plurality of indentations that is slotted has a variable width in the longitudinal direction.

11. The connector according to one claim 10, wherein the width of the and/or of at least one opening and/or at least one stiffness reduction structure decreases towards the center of the indentation and/or the stiffness reduction structures.

12. The connector according to claim 1, wherein the connector is in one piece.

13. The connector according to claim 1, wherein a central recess extends in the longitudinal direction from the actuation area via the elasticity area to the distal end of the mounting area.

14. A battery arrangement or fuel cell comprising:
a connector comprising:
an actuation area in the form of a head;
an elasticity area; and
a mounting area,
wherein the connector extends in a longitudinal direction,
wherein a radial direction is perpendicular to the longitudinal direction,
wherein the elasticity area lies in the longitudinal direction between the actuation area and the mounting area,
wherein the mounting area has an internal thread,
wherein the elasticity area and/or the mounting area are hollow on the inside, and
wherein the elasticity area has (i) stiffness reduction structures in the form of recesses and/or openings, and/or (ii) a lower elasticity than the mounting area and/or than the actuation area due to its geometry.

15. A method of manufacturing a connector comprising the following steps:
providing a blank;
moulding of an actuation area in the form of a head by forming;
moulding of a hollow mounting area by forming;
moulding of an elasticity area by introducing stiffness reduction structures in the form of indentations and/or openings in the longitudinal direction between the actuation area and the mounting area.
